(19) United States
(12) Patent Application Publication
(10) Pub. No.: US 2013/0155327 A1
(43) Pub. Date: Jun. 20, 2013

(54) Method to Process Image Sequences with Sub-Pixel Displacements

(71) Applicant: Geoffrey Louis Barrows, Washington, DC (US)

(72) Inventor: Geoffrey Louis Barrows, Washington, DC (US)

(21) Appl. No.: 13/756,544

(22) Filed: Feb. 1, 2013

Related U.S. Application Data
(60) Provisional application No. 61/593,355, filed on Feb. 1, 2012.

(51) Int. Cl. H04N 5/14

(52) U.S. Cl. CPC H04N 5/14
USPC 348/571

(57) ABSTRACT

A method for reducing or removing sub-pixel displacements between images in a sequence of images is disclosed. In the first step, a set of images is acquired using a camera system. In the second step, pairwise distances are computed between every pair of images of the set of images. In the third step, the pairwise distances having the smallest values are identified. In the fourth step, “lucky” image pairs are selected from the image pairs having the smallest displacement. These “lucky” image pairs will have a substantially reduced sub-pixel jitter. In an alternative embodiment, after performing the first step and before performing the second step, the set of images are processed to remove whole pixel displacements between the images in the set of images.

This application claims the benefit of provisional patent application Ser. No. 61/593,355 filed 2012 Feb. 1 by the present inventor.

### FEDERALLY SPONSORED RESEARCH

This invention was made with Government support under Contract No. FA8651-09-C-0178 awarded by the United States Air Force. The Government has certain rights in this invention.

### TECHNICAL FIELD

The teachings presented herein relate to the processing of image sequences.

### BACKGROUND

The acquisition and processing of images from a robotic platform is an important topic, especially with robots finding increasing use in various applications both civil and military. This includes the acquisition and processing of images from small robots, whether ground or airborne e.g. “micro air vehicles”. Sample image processing tasks include perceiving other objects in the environment, whether for obstacle avoidance, for tracking, or for general manipulation. A challenge associated with image acquisition and processing from smaller scale robots, however, is that of motion of the vehicle itself. This motion includes both the dynamic motion of the vehicle as it moves through space and mechanical jitter of the platform itself. Mechanical jitter can be particularly troublesome for smaller flying robots, since such jitter may be caused by the spinning of any propeller or rotor or the movement of any other actuator. Such mechanical jitter may be difficult to eliminate on small platforms due their inherent low mass.

The effect of such platform motion is that for any camera system located on the platform, it is difficult to acquire two sequential images of a scene that are precisely aligned. Instead, there will almost always be horizontal and vertical displacements between the two images, possible including whole-pixel displacements but certainly including sub-pixel displacements. (There may also be roll displacements if the camera is rotating on its lens axis.) Depending on the application, the total displacement between two images may several pixels or more. Whole-pixel displacements may be removed by shifting images horizontally and/or vertically by whole-pixel amounts, essentially to create an “aligned stack of images”, however there will be remaining sub-pixel displacements. The effect of such displacements can be profound over regions of the image with high spatial frequencies, such as edges, small spots, or other texture features. These sub-pixel displacements can make it difficult to analyze changes between the two images, including distinguishing differences between images due to platform motion from differences due to objects of interest such as obstacles and other moving objects. It is therefore desirable to find a way to reduce or eliminate both whole-pixel and sub-pixel displacements resulting from platform motion, including mechanical jitter, that occurs in images taken from moving platforms. If possible, it is also desirable to find image processing techniques that take advantage of platform motion including mechanical jitter.

Optical Flow and Local Optical Flow

The concept of optical flow has been discussed extensively. Optical flow is the apparent visual motion seen from a camera (or eye) that results from relative motion between the camera and other objects or hazards in the environment. For an introduction to optical flow including how it may be used to control air vehicles, refer to the paper, which shall be incorporated herein by reference, entitled “Biologically inspired visual sensing and flight control” by Barrows, Chahl, and Srinivasan, in the Aeronautical Journal, Vol. 107, pp. 159-168, published in 2003. Many algorithms exist for computing optical flow. One algorithm is the venerable Lucas-Kanade, which is described in the paper “An iterative image registration technique with an application to stereo vision” by B. D. Lucas and T. Kanade and published in 1981. The contents of this paper shall also be incorporated herein by reference. It will be understood that the displacements between images mentioned above, including sub-pixel displacements, resulting from platform motion are a form of optical flow.

We also introduce the concept of local optical flow. Local optical flow refers to the residual optical flow that exists after global optical flow has been removed. Generally in the context of a camera system, this refers to the removal of a global optical flow component. The global optical flow component may be an average or similar function of the entire optical flow in the field of view. The global optical flow component may instead be the optical flow associated with a particular point on an object in the visual field.

Refer to FIGS. 1A, 1B, and 1C for a more detailed depiction of local optical flow. FIG. 1A shows an air vehicle 101 moving through an environment 103. Suppose the air vehicle 101 contains a camera 105 which is oriented to image an object 107 in front of a background 109. Suppose the air vehicle 101 ascends from a first position 111 to a second position 113 as shown in the figure, and at the same time the air vehicle 101 is pitching upward, also as shown in the figure.

FIG. 1B depicts a sample optical flow pattern 151 that would be visible from the camera 105. As a result of the motion of the air vehicle 101, the optical flow vectors are strong in magnitude and pointed downward. Some optical flow vectors, for example vectors 153 and 155, correspond to optical flow due to the background 109, while other optical flow vectors, for example 157 and 159, correspond to optical flow due to the object 107. Optical flow vectors 157 and 159 will be slightly larger in magnitude than optical flow vectors 153 and 155 in this example due to the fact that the object 107 is closer to the air vehicle 101 than the background 109.

Now suppose the exact same scenario were repeated, except that the camera 105 were attached to the air vehicle 101 with a mechanical gimbal (not shown), and the mechanical gimbal is able to keep the camera pointed in the direction of a fixation point 115 as the air vehicle 101 moves. FIG. 1C depicts a sample optical flow pattern 171 obtained from the camera 105 on a gimbal. The optical flow at the fixation point 115 will be zero, while the optical flow associated with the background 109 will be zero or a small value. However the optical flow vectors (e.g. 173) associated with the object 107 will be pointing downwards, due to the apparent motion of the object 107 against the background 109. The apparent visual motion of the of the object 107 against the background 109 may referred to as “parallax”.

Local optical flow is essentially the residual optical flow that exists after the global optical flow has been removed. In the case of FIG. 1C, the global optical flow was removed using a mechanical gimbal. The global optical flow may also be removed computationally, for example by starting with the optical float pattern 151 of FIG. 1B, computing the optical flow at the fixation point 115, and subtracting this value from the optical flow values elsewhere in the image. The residual optical flow would be a local optical flow field.

It will be understood that various local optical flow patterns are possible. For example, if the air vehicle 101 were traveling forward towards the object 107 or the background 109, the local optical flow pattern would show an expanding or divergent pattern. Even in the exact scenario depicted in FIG. 1A, the local optical flow associated with the background 109 will not be zero, but have a small value corresponding to the shape of the background 109 and the motion of the air vehicle 101. Local optical flow can thus be useful to perceive the shape of an object.

A challenge associated with computing local optical flow, however, is that in some cases local optical flow can be extremely small, including a fraction of a pixel. In this case, any sub-pixel displacements between images resulting from mechanical motion can be stronger in magnitude than the local optical flow pattern, and can thus make it difficult to precisely measure local optical flow.

Preliminaries

For purposes of discussion, we shall refer to “sets” or “bursts” of images, which are generally collections of more than one image acquired from an image sensor. Each image within a set of images will generally be associated with a time instant in which it was acquired. The teachings below will describe cases in which each image is associated with a unique time instance, as well as cases in which more than one image may be associated with the same time instant.

For purposes of discussion, we shall use the notation I_{f} to refer to image f of a set I of F images, such that set I contains images I₁, I₂, . . . , and I_{F}. We shall use I_{f}(m,n) to refer to the pixel intensity at row m and column n of image I_{f}. Similarly, for an image A, A(m,n) refers to the pixel intensity at row m and column n of image A. We shall use M and N to denote respectively the number of rows and columns in an image. For purposes of discussion, pixel (1,1) will refer to the top left pixel of an image, while pixel (M,N) will refer to the bottom right pixel of the image.

For purposes of discussion, a single image or a set of images will be described as being generated by a digital camera system located on a platform. In the teachings below, we will describe the platform as moving through the environment, however this is a non-limiting description and it will be understood that the teachings below may be applied to other scenarios in which the camera is not attached to a moving platform. The moving platform may be a ground or airborne robot, or may be any other platform that moves with respect to the environment. The camera on the platform may undergo motion which may comprise both the general motion of the platform, for example caused by moving or navigating from one location to another or by the platform itself rotating, and mechanical jitter due to vibrations, which may be caused, for example, by actuating or drive mechanisms. The digital camera system will generally comprise optics, an image sensor, and a processor. The purpose of the optics is to generate an image on the image sensor based on light from the visual scene, e.g. the visual texture due to objects in the environment. The purpose of the image sensor is to generate pixel signals based on the image projected onto it. The purpose of the processor is to operate the image sensor, acquire the generated pixel signals, store the resulting pixel information, and perform any other needed processing steps. The camera system is capable of generating a single image or one or more sets of images as described above.

For sake of discussion, the teachings below will assume the use of camera systems incorporating square pixel array image sensors that generate images in a 2D matrix form. Such is the format used by the majority of digital cameras at the time of writing. However it will be understood that the techniques may be applied to cameras using image sensors having other types of pixel arrays, including but not limited to hexagonal pixel arrays, rectangular pixel arrays, or pixel arrays of arbitrary shape.

Removing Whole Pixel Displacements

There are well-known techniques for removing whole pixel displacements. First, let us define a distance metric d( ) that computes how dissimilar two images are. This distance metric may be an Euclidean distance. In this case, the distance d(A,B) between image A and B will be

$$d ( A , B ) = \sqrt{\frac{1}{MN} {\sum }_{m , n} {( A ( m , n ) - B ( m , n ) )}^{2}}$$

where m and n vary over all pixels of A and B, and M and N denote respectively the number of rows and columns of A and B. When images A and B are equal, the distance metric d(A,B) will be zero. If A or B are changed to be less similar, the distance metric will increase. The distance metric d(A,B) can be considered a “dis-similarity metric” since it increases in value (e.g. becomes more positive) as the images A and B are less similar.

Suppose we have a set of images I₁ . . . I_{F} as described above. One way to remove whole-pixel displacements is to shift each image of the set I so as to generally minimize the overall distances d(Iᵢ,Iⱼ) between any two images Iᵢ and Iⱼ of I. One method of doing this is as follows: First acquire the set I of images. Second, select one image Iᵣ of I to be a reference image. Third, for every image Iᵢ, such that i≠r, perform the following: Shift Iᵢ horizontally and vertically so as to minimize d(Iᵣ,Iᵢ). Obviously after such shifting occurs, only the overlapping portions of the images would be included in the d(Iᵣ,Iᵢ) computation. Thus m and n in the above equation regarding distance metric d( ) vary over only pixels in which A and B overlap, and M and N denote respectively the size of the overlapping area of A and B. The reference image Iᵣ may be the first image I₁ or another image of I depending on the application or any circumstances.

A consideration of this method is that after such shifting occurs, the overlap between images will not be 100%. Therefore it will be necessary to crop the shifted images in the sequence so that they are the same size and overlap 100%. For example, if a first image is not shifted, and a second image is shifted to the right by 1 pixel, we will need to delete the left-most column of the first image and the right-most column of the second image.

Another way to remove whole pixel displacements is to use a block matching technique. This may be performed as follows: First, acquire the set of I images. Second, for the first image I₁, select an initial block of pixels W₁ within image I₁. It is beneficial for this block W₁ to contain a salient texture feature that is easy to track horizontally or vertically, for example a spot, end-point, or a corner feature. It may also be beneficial for this block W₁ to be near the center of the image I₁. For purposes of discussion, let us define the (m,n) coordinates of a block to be the smallest row and column pixel within the block. For example, if a block spans rows 31 through 41 and columns 43 through 53 of an image, the block has a size of 11 by 11 pixels and is located at (31,43). Third, for every image Iᵢ for i=2 through F, find the same-sized block of pixels Wᵢ in Iᵢ that best match W₁, e.g. that minimize d(W₁,Wᵢ). It may be beneficial to constrain the search for block Wᵢ to within a neighborhood of block Wᵢ₋₁ or W₁ Fourth, for every image Iᵢ for i=2 through F, shift image Iᵢ horizontally and vertically so that Wᵢ has the same (m,n) coordinates as W₁. Again, a result of this shifting is that the edge pixels of some or most images of I will be shared by only a subset of images.

For example, suppose block W₁ is located at (31,43), block W₂ is located at (33,43), and block W₁ is located at (34,44). We would then shift image I₂ up by 2 pixels, and then shift image I₃ up by 3 pixels and left by 1 pixel.

This technique of tracking a feature may be modified according to the specific environment or application. For example, it will generally be beneficial to constrain the search space for Wᵢ so that the position displacement between Wᵢ and Wᵢ₋₁ is constrained to within a search region. This will help prevent Wᵢ from being matched up to a similar looking but incorrect location of the visual field as W₁. It is also possible to implement this technique in a running manner, so that new images Iᵢ are processed and lined up as they are acquired. In other words it is not necessary to grab the entire sequence of images I before performing alignment. If available, the output of an inertial measurement unit may be used to assist with tracking the motion of the block W₁ across the subsequent images.

As suggested above, a consideration with both of the above methods is that if the whole pixel displacement is too large, the images may end up being shifted enough so that the overlap between image pairs is too small to be useful. This may have an effect on any post-processing performed on the resulting images. Thus, it is beneficial to constrain this technique to image sequences I whose maximum displacement is a reasonable fraction of the size of images of I. For example, if each image of I is 256×256 in size, it may be beneficial to ensure that the maximum displacements be less than 10, 20, or 50 pixels, depending on the application. In the case where block matching is used to measure and remove whole-pixel displacement, one method of enforcing a maximum displacement rule is to stop acquisition of new images if the window Wᵢ has traveled too far from its initial location as W₁ or is too close to the edge of the image Iᵢ.

Sub-Pixel Displacements

Even after whole-pixel displacements are removed, as stated above there will generally be residual sub-pixel displacements that remain. In regions of the image with little or no high spatial frequency texture, sub-pixel displacements between two images will have little impact. However in regions with strong high spatial frequencies, for example near a sharp edge, a small amount of sub pixel displacement can result in a large difference between corresponding pixel intensities around those regions in the two corresponding images. Thus there is still a need for removing such sub-pixel displacements. We summarize two prior art methods below.

Sub-Pixel Displacement Reduction Using Bilinear Interpolation

There is one method of removing sub-pixel displacements that is known in the prior art. Essentially an image may be shifted by a sub-pixel amount using bilinear interpolation techniques. For example, suppose two images have a relative sub-pixel displacement of a half a pixel in the horizontal direction, so that the second image is half a pixel to the right of the first image. This displacement may be reduced simply by shifting the first image to the right by one half a pixel. This may be performed by setting every pixel of the first image to the average of that pixel and the pixel to the right.

A problem with this technique is that it will never be able to completely remove the effects of sub-pixel displacement. It is true that after such a shifting has been executed, the center, in the visual field, of each pixel of the newly shifted first image will be approximately equal to the center of the corresponding pixel from the second image, with the “centers” of pixels referring to their respective locations in the visual field. Equivalently stated, the optical flow between the shifted first image and the second image will be near zero. However the act of shifting by bilinear interpolation necessitates that each pixel of the shifted image is based upon not just one photosensing pixel element, but two or more photosensing pixel elements. Thus the act of shifting by bilinear interpolation spatially smoothes the image being shifted. Thus when comparing the shifted first image with the second image, one would compare an image that has undergone a smoothing operation with an image that has not.

Sub-Pixel Displacement Reduction Using Offset Downsampling

Another technique exists for reducing sub-pixel displacements before the image is digitized, using a technique referred to as “offset downsampling”. This technique is taught by Barrows in U.S. patent application Ser. No. 12/852,506 entitled “Visual motion processing with offset downsampling”. An image sensor capable of supporting offset downsampling is described in U.S. patent application Ser. No. 13/078,211 entitled “Vision based hover in place” also by Barrows. The contents of both U.S. patent applications are incorporated herein by reference. In this technique, an image sensor having binning is used to generate super pixels according to a finely spaced grid. From the perspective of the lower resolution image of super pixels, this technique is able to reduce sub-pixel displacement. However the sub-pixel displacement may still not be reduced to a value less than that allowed by the finely spaced grid. Another disadvantage of this technique, however, is that the act of binning reduces the resolution of an image, which may be undesirable for some applications.

It is therefore desirable to remove sub-pixel displacements without using bilinear interpolation and to a precision substantially finer than the pitch between pixels of an image sensor array.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A shows an air vehicle moving through an environment;

FIG. 1B depicts a sample optical flow pattern from the camera in FIG. 1A;

FIG. 1C depicts a sample optical flow pattern obtained from a camera on a gimbal;

FIG. 2 shows a scatter plot of 25 samples of random variable (X,Y);

FIG. 3 shows a method of selecting “lucky image pairs” from a set of images;

FIG. 4 shows a method of selecting “lucky pairs” of images between two sets of images;

FIG. 5 shows a moving air vehicle carrying a camera in an environment;

FIG. 6 shows a method of detecting a moving object against a background from a moving camera;

FIG. 7 shows an air vehicle traveling along a path in its forward direction; and

FIG. 8 shows an image region over which divergence may be computed; and

FIG. 9 shows a camera mounted on a gimbal moving from a first position to a second position.

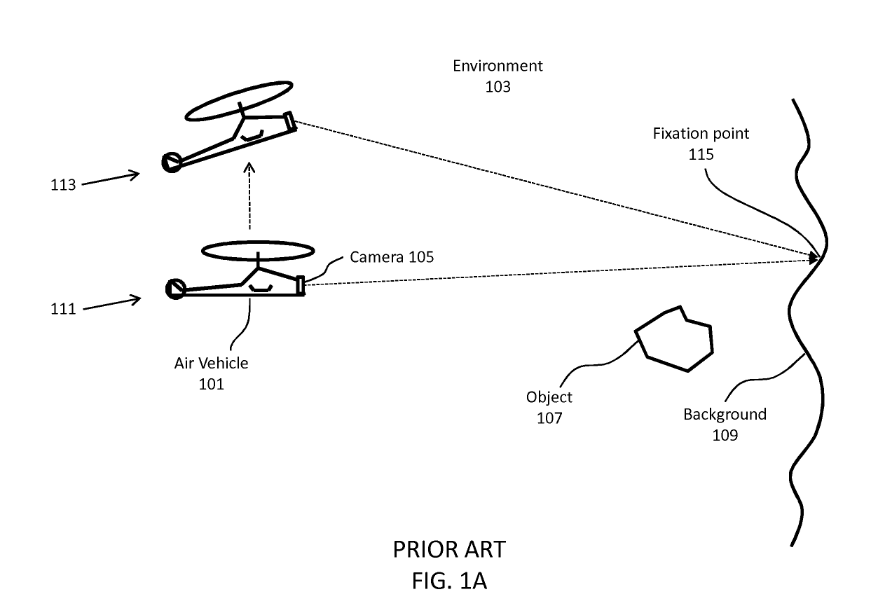

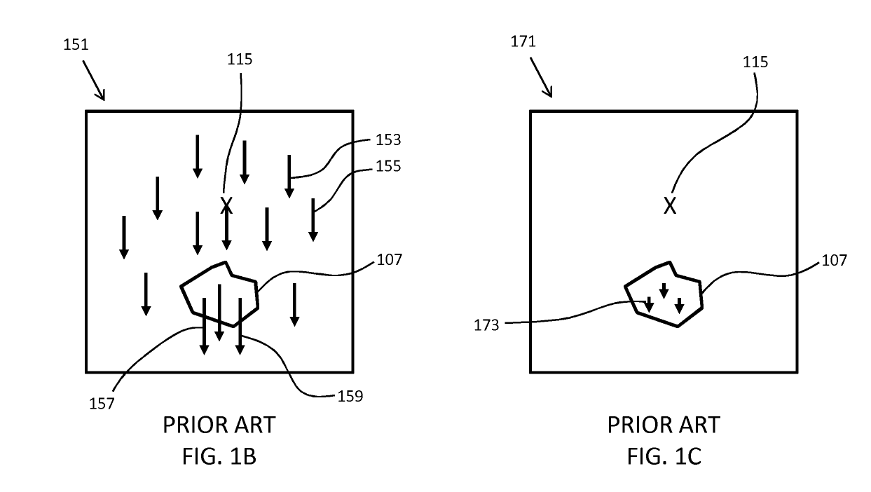

### DESCRIPTIONS OF EXEMPLARY EMBODIMENTS

In the teachings below, the word “beneficial” will be used to denote a characteristic, detail, or specification that may be desirable to improve the performance of the exemplary embodiments described herein. It will be understood, however, that the word “beneficial” does not mean “required” and is not a limiting term. It will be understood that if any characteristic, detail, or specification is described as “beneficial”, the characteristic, detail, or specification so described is not necessarily required for some applications of the teachings herein.

Birthday Paradox

The teachings below will describe a method of substantially reducing or removing such sub-pixel displacements using an implication of probability theory. Let X be a random variable uniformly distributed between 0 and 1. If ten samples of X are generated, and sorted from lowest to highest, one would intuitively think that the average distance between sequential sorted samples will be about 0.1. However, in reality some sequential sorted samples will be closer than 0.1 to each other and other sequential sorted samples farther apart than 0.1 to each other. Chances are at least one of the sequential pairs will be much closer together than 0.1. For example, consider this sequence of ten randomly generated samples of X (rounded to the thousandths):

{0.815, 0.906, 0.127, 0.913, 0.632, 0.098, 0.279, 0.547, 0.958, 0.965}
When sorted, these become:
{0.098, 0.127, 0.279, 0.547, 0.632, 0.815, 0.906, 0.913, 0.958, 0.965}
Note that two numbers, 0.279 and 0.547, are more than 0.2 apart. More interestingly, note that two other numbers, 0.958 and 0.965, are different by 0.007, which is substantially less than 0.1. This phenomena is responsible for the so-called “Birthday Paradox”, in which in a classroom of just 30 children, the odds favor two children having the same birthday, which is counterintuitive to the fact that there are 365 days in the year. The pair of numbers 0.958 and 0.965 are analogous to the two children in a class having the same birthday.

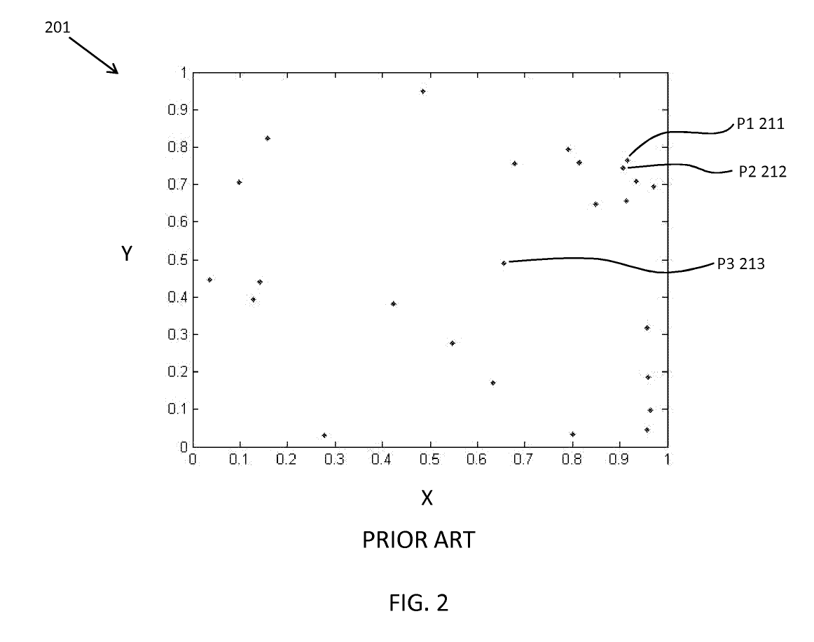

This observation extends to two dimensions. Let us again consider a two dimensional random variable (X,Y) that generates an (x,y) pair, with X and Y independent and uniformly distributed between 0 and 1. FIG. 2 shows a scatter plot 201 of 25 randomly generated samples of (X,Y). Note that some points (for example point P3 213) are isolated from other points, while there are other points (for example points P1 211 and P2 212) that are very close together. These close-together points are also analogous to the two children in a class having the same birthday.

For purposes of discussion, suppose we have a population of samples of a random variable. We shall refer to any two samples that are substantially closer together than expected as a “lucky pair”. Thus numbers 0.958 and 0.965 are “lucky pairs” of the above population of ten samples of X. Similarly points P1 211 and P2 212 of FIG. 2 may also be referred to as “lucky pairs”.

Suppose we have a set of images that are substantially identical except for random sub-pixel displacements. The sub-pixel displacements of each image of the set with respect to a reference displacement may be considered a two dimensional random variable (X,Y) much like that shown in FIG. 2. Thus, it stands to reason, the “lucky pair” observation shown in FIG. 2 implies that there will be one or more pairs of images in the set of images that have small sub-pixel displacements with respect to each other. Such pairs of images with low relative displacement may be referred to as “lucky image pairs”.

Sub-Pixel Displacement Reduction within a Set of Images

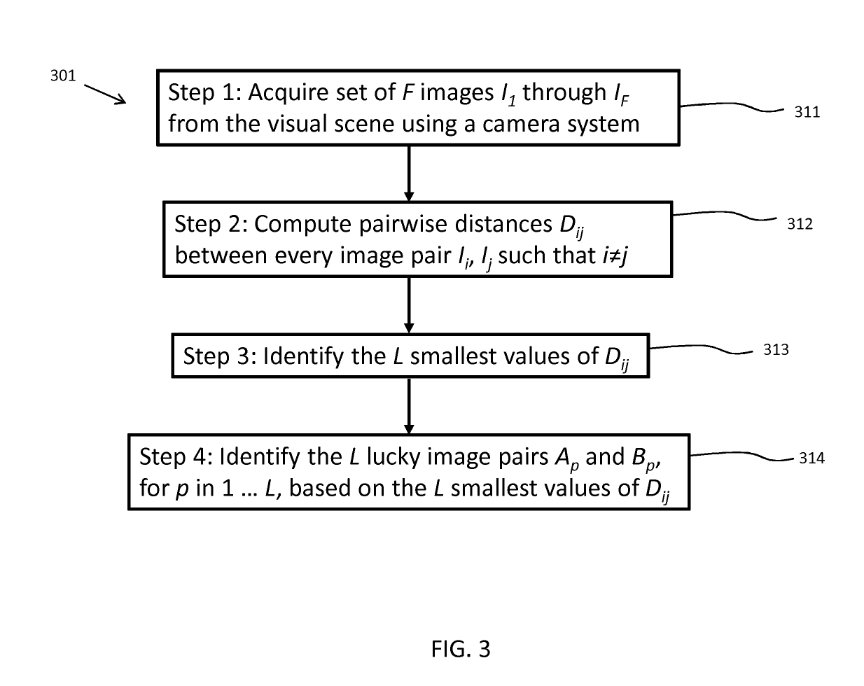

Suppose a camera system mounted on a platform acquires a set I of images I₁ . . . I_{F}, where each of these images is acquired at a different time instant. Suppose that the camera undergoes a small amount of motion so that the displacements between different images of I is on the order of a fraction of a pixel or less. Refer to FIG. 3, which shows a method 301 of selecting “lucky image pairs” from a set of images such that the relative displacements between the two images of a lucky pair have minimal displacement between them. The method may be implemented as follows:

Step 1 (311): Acquire a set of F images I₁, . . . I_{F} from the visual scene using the camera system. It is beneficial for each image of set I to be acquired at a different time instant.

Step 2 (312): Compute a set of distances between every pair of images of set I. Exclude pairs comprised of the same image twice. More specifically, for every i and j such that i≠j, set Dᵢⱼ=d(Iᵢ,Iⱼ), where d( ) is the distance function described above or is another mismatch function that increases in magnitude as the two compared images become less similar. If Dᵢⱼ is computed, it is not necessary to compute Dⱼᵢ since d( ) is symmetric. If there are a total of F images, then there will be a total of (F(F−1)/2) distances computed.

Step 3 (313): Search through the values of Dᵢⱼ to find the L values that have the smallest values. This may be performed by sorting Dᵢⱼ in increasing order, and selecting the first L values of the sorted list, as discussed below. Generally L<<(F(F−1)/2).

Step 4 (314): Select the image pairs associated with the L best values of Dᵢⱼ. These image pairs may be denoted as Aₚ and Bₚ, where p is between 1 and L. These L image pairs Aₗ and Bₗ through A_{L} and B_{L} may be referred to as “lucky pairs” of images, since they may have a substantially small amount of sub-pixel displacement between them. This concludes the method.

Let us provide an example of how Steps 3 (313) and 4 (314) may be performed. Suppose F=7 so that set I contains seven images I₁ through I₇, resulting in a total of 21 pairwise distances Dᵢⱼ. We can perform Step 3 (313) by constructing a 21×3 matrix, with each row of the matrix storing a row vector of the form [Dᵢⱼij], and then sorting the rows according to the contents of the left most column. For example, suppose the unsorted matrix, written in MATLAB format, is:

$$Unsorted = [ \begin{matrix}81.4724 & 1 & 2 \\ 90.5792 & 1 & 3 \\ 12.6987 & 1 & 4 \\ 91.3376 & 1 & 5 \\ 63.2359 & 1 & 6 \\ 9.7540 & 1 & 7 \\ 27.8498 & 2 & 3 \\ 54.6882 & 2 & 4 \\ 95.7507 & 2 & 5 \\ 96.4889 & 2 & 6 \\ 15.7613 & 2 & 7 \\ 97.0593 & 3 & 4 \\ 95.7167 & 3 & 5 \\ 48.5376 & 3 & 6 \\ 80.0280 & 3 & 7 \\ 14.1886 & 4 & 5 \\ 42.1761 & 4 & 6 \\ 91.5736 & 4 & 7 \\ 79.2207 & 5 & 6 \\ 95.9492 & 5 & 7 \\ 65.5741 & 6 & 7\end{matrix} ]$$

The above matrix encodes D_{1,2}=81.4724, D_{1,3}=90.5792, and so on. We can then row sort this matrix (for example using the MATLAB “sortrows” function), sorting the first column, to obtain the sorted matrix:

$$Sorted = [ \begin{matrix}9.7540 & 1 & 7 \\ 12.6987 & 1 & 4 \\ 14.1886 & 4 & 5 \\ 15.7613 & 2 & 7 \\ 27.8498 & 2 & 3 \\ 42.1761 & 4 & 6 \\ 48.5376 & 3 & 6 \\ 54.6882 & 2 & 4 \\ 63.2369 & 1 & 6 \\ 65.5741 & 6 & 7 \\ 79.2207 & 5 & 6 \\ 80.0280 & 3 & 7 \\ 81.4724 & 1 & 2 \\ 90.5792 & 1 & 3 \\ 91.3376 & 1 & 5 \\ 91.5736 & 4 & 7 \\ 95.7167 & 3 & 5 \\ 95.7507 & 2 & 5 \\ 95.9492 & 5 & 7 \\ 96.4889 & 2 & 6 \\ 97.0593 & 3 & 4\end{matrix} ]$$

The top-most rows indicate the “lucky pairs” of images having a lower mismatch. Suppose L=4. The “lucky pairs” of images will be determined by the first four rows of the sorted matrix.

Then, in order to perform Step 4 (314), we would set Aₚ and Bₚ respectively to the second and third elements of the corresponding top-most rows. Thus A₁=I₁, A₂=I₁, A₃=I₄, A₄=I₂, B₁=I₇, B₂=I₄, B₃=I₅, and B₄=I₇. Of course, for implementation rather than copying matrices into Aₚ and Bₚ, we could just set Aₚ and Bₚ to pointers to the appropriate images in order to save memory.

Sub-Pixel Displacement Reduction Between Sets of Images

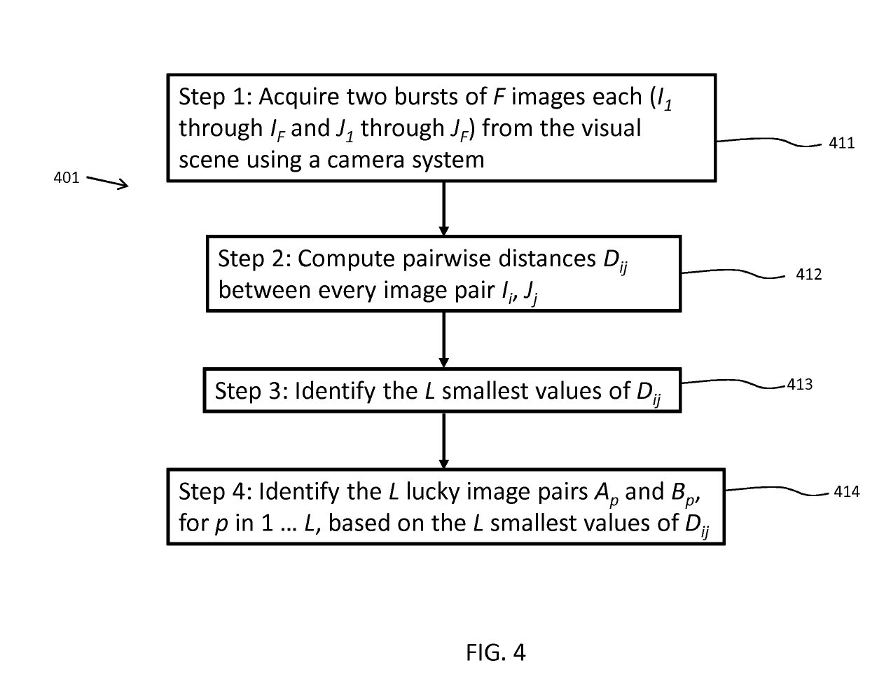

Refer to FIG. 4, which shows a method 401 of selecting “lucky pairs” of images between two sets of images, where one image of a lucky pair comes from one of the image sets and the other image of the lucky pair comes from the other image set, such that the relative displacements between the two images of a lucky pair have minimal displacement between them. This method may be performed in four steps, which are similar to the method 301 of FIG. 3.

Step 1 (411): Acquire two sets of F images each I₁ . . . I_{F} and J₁ . . . J_{F} from the visual scene. It is beneficial for set/to contain images acquired during one time interval, and for set J to contain images acquired during a second time interval, in which the two respective time intervals may be nonoverlapping. It is also beneficial for each image to be acquired at a different time instant.

Step 2 (412): Compute a set of distances Dᵢⱼ between every permutation of an image from set I and an image from set J. In other words, for each i and j in 1 . . . F, set Dᵢⱼ=d(Iᵢ,Jⱼ). Distance metric d( ) may be the same metric used above in method 301 of FIG. 3. There will be a total of F² distances computed.

Step 3 (413): Search through the values of Dᵢⱼ to find the L values that have the smallest values. This may be performed in a similar manner as Step 3 (313) for the algorithm 301 described above in FIG. 3, including by constructing matrix “Unsorted” as described above, row-sorting the matrix “Unsorted” to generate “Sorted”, and then identifying the L lucky pairs from the sorted matrix.

Step 4 (414): Select the image pairs associated with the L best values of Dᵢⱼ. In the same manner as Step 4 (314) of the algorithm 301 of FIG. 3, select L image pairs Aₚ and Bₚ, where p is between 1 and L, Aₚ is the corresponding image from set I and Bₚ is the corresponding image from set J. The index of the images that form these pairs are identified by the first L rows of matrix “Sorted”. This concludes the method.

Variations to Save Cpu Cycles

Generally the most computationally complex part of implementing the above algorithms 301 and 401 will be the computation of Dᵢⱼ over all image pairs. Indeed, suppose we are searching for lucky pairs within an image set I, which contains 20 images, and that the images are 100×100 in resolution. There would be 190 image pairs, with 10,000 pixels compared for each image pair, resulting in approximately 1.9 million multiplies and 3.8 million add/subtracts to compute Dᵢⱼ over the entire set. (Larger sized images or larger set sizes would grow the CPU complexity quadratically.)

Of course, if one had access to a parallel processing system, then the computation of all Dᵢⱼ values could be performed in a parallel manner. Indeed the computation of all Dᵢⱼ values would be an “embarrassingly parallel” algorithm. However in the absence of such hardware, several techniques may be utilized to reduce the computational complexity of this algorithm with minimal performance degradation.

Method 1: One method is to simply compute Dᵢⱼ over just a subset of the entire image. For example, rather than using all pixels to compute metric do, one may use pixels from only some rows and/or some columns. Utilizing only pixels that are both in every fourth row and every fourth column would reduce the number of pixels use to compute d( ) by 16, and thus reduce the computational complexity by about the same factor.

Method 2: Another method is to pre-search the image for regions with higher spatial contrast and/or local spatial variation, and concentrate the computation of Dᵢⱼ over just these areas. In this case, it is beneficial for several such areas to be selected that are scattered over the entire field of view, so that potential variations in camera roll may be handled as well.

Method 3: A third method is to use a pre-screening method—Initial Dᵢⱼ values may be computed over a limited portion of the image, perhaps using only a subset of rows and/or columns, or perhaps using a few pre-selected areas. Image pairs having higher Dᵢⱼ values may be eliminated in this stage. Then, of the image pairs that remain, a more comprehensive Dᵢⱼ may be recomputed using a larger portion of the image or the entire image. This method may substantially allow the benefits of an exhaustive image comparison without having to compute a full-image Dᵢⱼ over all image pairs.

Variations of Distance Metrics

The above-mentioned distance metric d( ) is one of many measurements that may be used to compare images for identifying “lucky pairs” of images. For example, a sum of absolute differences measurement may be used, generated by the sum of the absolute values of the pixel differences. Other types of measurements such as optical flow may be used, in which d(A,B) is set to the absolute value of the two-dimensional optical flow computed between A and B, computed using the Lucas-Kanade or another optical flow algorithm. It also possible to use for d( ) a measurement function that increases e.g. becomes more positive when images A and B are more similar. In this case, the “lucky image pairs” would be those whose measurement function d( ) is more positive. Essentially, it will be understood that any function that computes similarity or dissimilarity between two images is a candidate measurement function that may be used for the teachings herein.

Displacement Reduction when Displacement is More Than a Pixel

In some applications the displacements may be more than a pixel. This may be a result of larger mechanical vibrations, or this may be a result of a longer time interval between the acquisition of images. In this case, it is beneficial to remove whole-pixel displacements before implementing the algorithms 301 and 401 shown in FIGS. 3 and 4. More specifically, after Step 1 (311 or 411), the acquisition of the images, and before Step 2 (312 or 412), the computation of Dᵢⱼ values, one may use one of the above prior art methods of removing whole-pixel jitter or whole-pixel displacements. In the case of algorithm 401, it may be necessary to perform this step of removing whole-pixel displacements or jitter over both image sets I and J. As suggested above, before proceeding to Step 2 the shifted images will likely need to be cropped so that the resulting set of images are the same size and overlap 100%. The resulting images will then have a residual sub-pixel jitter that may be reduced using Steps 2 (312 or 412) through 4 (314 or 414).

Applications

A primary benefit of the above steps is that the L lucky image pairs will generally have less sub-pixel displacement between them than a pair of images selected at random. Furthermore some of the lucky image pairs may have been taken relatively far apart in time, thus allowing enough time for local optical flow and similar effects to manifest themselves. This may make it easier to process image pairs for differences that may be indicative of moving objects, local optical flow, and so forth. We discuss a number of example applications below.

Detecting a Moving Object from a Moving Camera

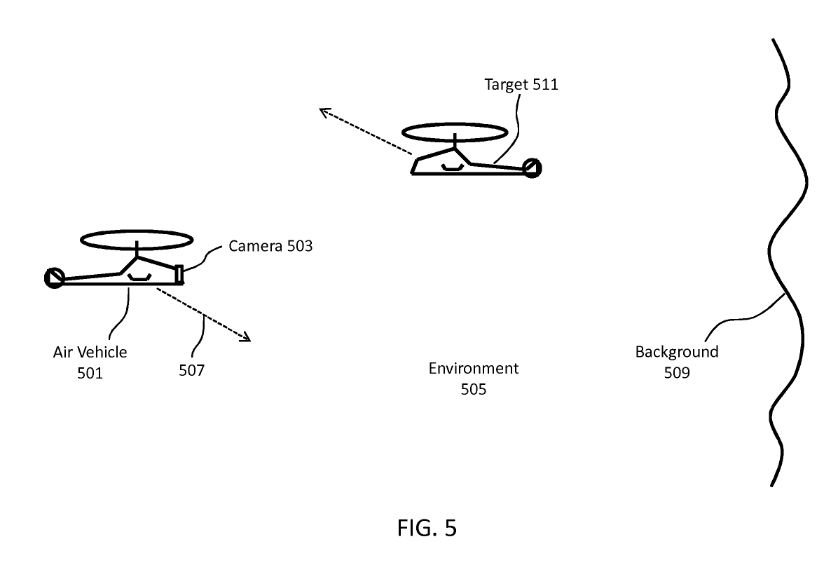

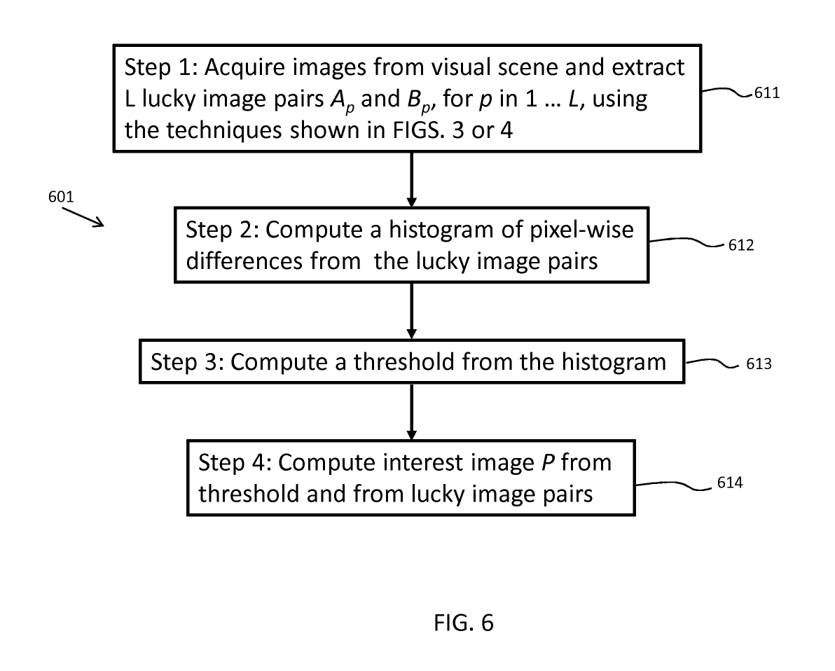

Refer to FIG. 5, which shows a moving air vehicle 501 carrying a camera 503 in an environment 505. The moving air vehicle 501 is traveling in one direction 507, and nearby are a background 509 and a target air vehicle 511. Let us now address the problem of detecting the moving target 511 from the camera 503 being carried on the moving air vehicle 501. One method is to acquire one or two sets of images, extract lucky image pairs having low sub-pixel displacement between them, and then analyzing changes that occurred between the lucky image pairs. Because the general sub-pixel jitter between lucky image pairs is small, any individual pixels that have substantially changed are candidate locations of an object (e.g. 511) that is moving relative to the background 509. It may be possible to identify the moving target (511) merely by looking for individual pixels within a lucky pair of images that are different by more than a predetermined threshold θ. In other words, for lucky image pair Aₚ and Bₚ, a pixel (m,n) may be a candidate location for a moving object if |A_{P} (m,n)−Bₚ(m,n)|≧θ. This “frame difference” technique may be applied to all L lucky image pairs, and an interest image P may be computed by counting how many times, over all L lucky image pairs, the pixel difference exceeds the threshold. In other words

$$P ( m , n ) = {\sum }_{p = 1 … L} 1 ( \vert {A}_{p} ( m , n ) - {B}_{p } ( m , n ) \vert \geq θ )$$

where the 1( ) function converts a Boolean value to an integer 1 or 0 respectively for “true” or “false”. Pixels P(m,n) with a high value, or small regions of P with a number of pixels having non-zero values, are candidate locations for a moving object such as the target 511.

In some cases, the target 511 to be detected is very small or there may be strong distracting texture on the background 509 or even between the camera 503 and the target 511 (for example tree branches). In this case it may be beneficial to use an adaptive threshold. One method is to adapt the threshold θ according to the measured background contrast in the environment so that it is more positive in regions of the image with higher spatial contrast. For example, it is possible to compute the absolute value differences between each pixel and its neighbors, and do so over all images in the sequence, and set the threshold θ to a constant multiplied by the mean or other statistic of the absolute value differences, so that the threshold θ is more positive for pixels surrounded by high contrast texture. In this case, the threshold θ may be written as θ(m,n) since it varies for each pixel. Alternatively, threshold θ may be adaptively computed using the algorithm described next. Refer to FIG. 6, which shows a method 601 of detecting a moving object against a background from a moving camera.

Step 1 (611) is to acquire one or two sets of images to work with, and extract L lucky image pairs using the methods described above. This may be performed using one set of images as performed in the method 301 of FIG. 3 or using two sets of images as performed in the method 401 of FIG. 4. Depending on the amount of visual motion, it may be also beneficial to incorporate one of the prior art steps to remove whole-pixel motion, as described above. The outcome of this step will be a set of L image pairs Aₚ and Bₚ, with p in 1 . . . L.

Step 2 (612) is to compute a histogram of pixel-wise differences from the lucky image pairs. If the pixel values are integer valued, essentially we may compute:

$${H}_{i} = {\sum }_{p = 1 … L , m = 1 … M , n = 1 … N} 1 ( \vert {A}_{p} ( m , n ) - {B}_{p } ( m , n ) \vert = i )$$

Thus the value Hᵢ is the number of pixels, over all L lucky image pairs and all pixels within each lucky image pair, such that the difference between the pixel in the A image and the B image is equal to i. If the pixels are real-valued, we may round the pixels into integer values first before computing the above histogram equation.

Step 3 (613) is to compute a threshold based on the histogram. Essentially search for the most positive value of θ such that

(H_{θ}+Hθ+1+H_{θ+2} . . . )≧Q.

The value θ is the adaptive threshold. Over all L lucky pairs of images, there will be at least Q pixels whose frame difference |Aₚ(m,n)−Bₚ(m,n)| is greater than or equal to θ.

Optionally, one may also put a lower limit on θ, so that θ does not drop below a predetermined value. This may be helpful in preventing false positive detections of objects when none exist.

Step 4 (614) is to compute an image P as follows:

$$P ( m , n ) = {\sum }_{p = 1 … L} 1 ( \vert {A}_{p} ( m , n ) - {B}_{p } ( m , n ) \vert \geq θ )$$

The image P will contain mostly zeros, with non-zero values indicating the potential locations of a moving object. In some scenarios the moving object may move across the visual field over a set of images. In this case, the location of non-zero pixels in P can trace out the “path” of the object, thus P may be referred to as a “path image”.

For a specific application, the algorithm 601 will benefit from empirical selection of values of L and Q to obtain optimal performance. In practice, we have found it beneficial to set L to a small fraction, less than 20%, of all available lucky pairs. Too small a value of L will produce too few image pairs for extracting information, while too high a value of L will allow “less lucky” pairs to contribute noisy measurements and false targets. Likewise the value of Q may similarly be adjusted, with smaller values decreasing the sensitivity of the algorithm but larger values of Q potentially allowing false targets to be detected. The optimal values for L and Q will clearly depend on the application. However as a starting point, suppose F=40, which would produce a total of 780 pairs. We would suggest starting with a value between 10 and 150 for L and a value between 5 to 100 for Q as an initial starting point from which more optimal values of L and Q may be obtained.

When acquiring one or more sets of images with which to apply the above algorithm 601, the timing of the acquisition of these images will have an impact on the performance of the above algorithms. In the case of detecting a moving target, it may be beneficial to spread out the acquisition of the set of images so that the target moves enough against the background to be detected. If the images are acquired too close together in time, the moving target may not have had a chance to move and thus may not stand out. In other words, it is beneficial to tune the image acquisition rate to the application.

An interesting observation of the above technique 601 to detect moving objects (e.g. 511) from a moving camera (e.g. 503) is that the moving object is detected primarily by frame differencing, e.g. computing the direct pixel-wise difference between two images. If the prior art step of removing whole-pixel displacements by shifting is not used, then the corresponding pixels in two images are acquired by the same corresponding pixel circuits. Any offset or nonuniformities, such as fixed pattern noise, is a common term that may be cancelled out by the pixel-wise difference. Thus, in this case it is possible to detect moving objects even when the image data coming from the camera has not been processed to remove fixed pattern noise.

Detecting a Narrow Object by Parallax

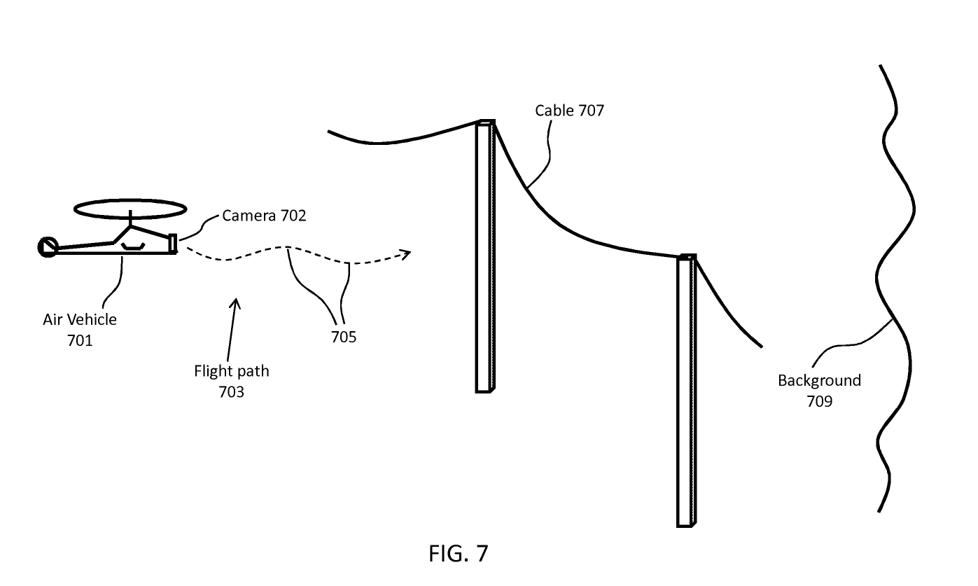

A similar method may be used to detect narrow obstacles using parallax. Refer to FIG. 7, which shows an air vehicle 701 traveling along a path 703 in its forward direction. The path 703 is not perfectly straight, and instead includes small perturbations 705. These perturbations 705 may be intentional or unintentional, for example resulting from environmental factors or from the general feedback loop used to control the air vehicle 701. Suppose there is a narrow object, such as a cable 707 (or other object) in the general path of the air vehicle 701, and that the cable 707 is substantially closer to the air vehicle 701 than the background 709. It will be possible to detect the cable 707 from the background 709 using parallax that exists between the cable 707 and the background 709. Essentially as the vehicle 701 makes perturbations 705, the cable 707 will appear to move against the background 709. The cable 707 may then be detected using the algorithm 601 shown in FIG. 6, or other techniques incorporating algorithms 301 or 401.

The aforementioned issues on the timing of the acquisition of the images apply also to the problem of detecting a narrow object such as the cable 707 by parallax. If the images are acquired over a too small time interval, the narrow object will not appear to move against the background and may be missed. It is thus beneficial to tune the image acquisition rate to the dynamics of the air vehicle carrying the camera and the general size of the environment.

Measuring Divergence

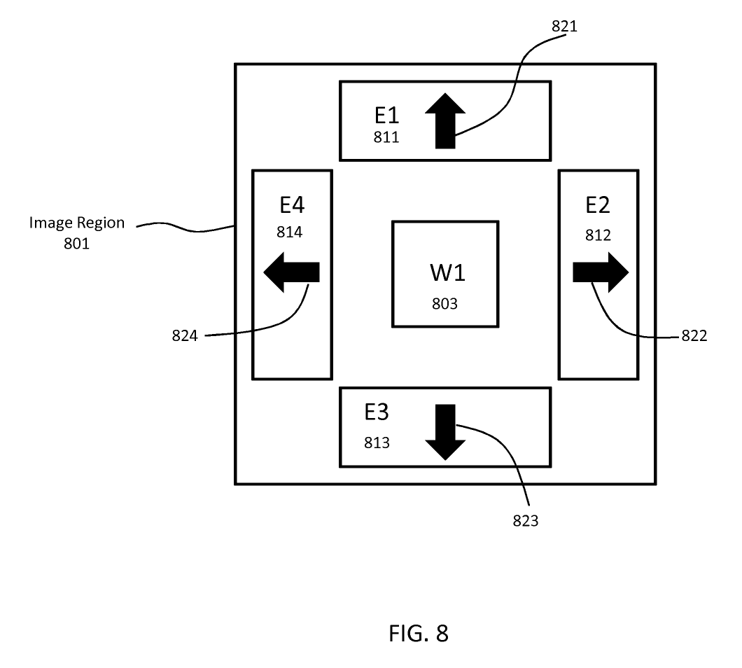

The “lucky pair” method described above may also be used to improve measurements of optical flow divergence. Optical flow divergence is the expanding optical flow pattern that might be experience by air vehicle 101 if it were flying towards the background 109. Refer to FIG. 8, which shows an image region 801 over which divergence may be computed. Divergence may be computed as follows: First, acquire one or two sets of images. Second, select lucky image pairs based using one of the algorithm 301 or 401 described above. However for computing lucky pairs, it may be beneficial for the computations of Dᵢⱼ to be performed over a compact region in the center of the images, for example central region W₁ 803 in FIG. 8, as opposed to over the whole image. This is particularly true if that region is known to be the approximate direction of travel. If a step for removing whole-pixel displacements is performed, this may be performed using the central region W₁ 803 as a block of texture to be tracked across the sequence of images. Third, select a single lucky pair of images that best covers the time period over which divergence may be measured. For example, if lucky image pairs are computed within a single set of images, one may select a lucky image pair that comprises one of the earlier images of the set and one of the later images of the set. On the other hand, if the lucky pairs are computed between two sets of images, and the respective time intervals of the two images are sufficiently far apart, then the best lucky pair alone may suffice. Fourth, compute divergence using the selected lucky image pair. This may be performed using any known technique to compute optical flow divergence. One method is to divide up the periphery of the image region 801 into four edge regions E₁ (811) through E₄ (814) as shown in FIG. 8. Then optical flow may be computed in the four regions between the two images. Finally the divergence may be computed based on the projection of the 2D optical flow vectors from regions 811, 812, 813, and 814 onto the respective orientation vectors of each region, 821, 822, 823, and 824, as shown in FIG. 8. The sums of the projections will be a measurement of optical flow divergence.

To obtain additional accuracy, it may be beneficial to select several lucky image pairs, compute a divergence measurement from each lucky image pair, and then average or otherwise combine the computed divergences.

As in the other applications mentioned above, it is beneficial to tune the acquisition rate of the images to the amount of divergence that generally exists in a given application.

Extracting Local Optical Flow

The set of steps just described to measure divergence may also be used to measure general local optical flow. The difference is that rather than computing optical flow over just regions E₁ 811 through E₄ 814, a denser optical flow field may be computed over the image regions using any established optical flow method. The resulting optical flow fields will be local optical flow, which may be used to gather information about the structure of the visual field.

Use in a Gimbaled System

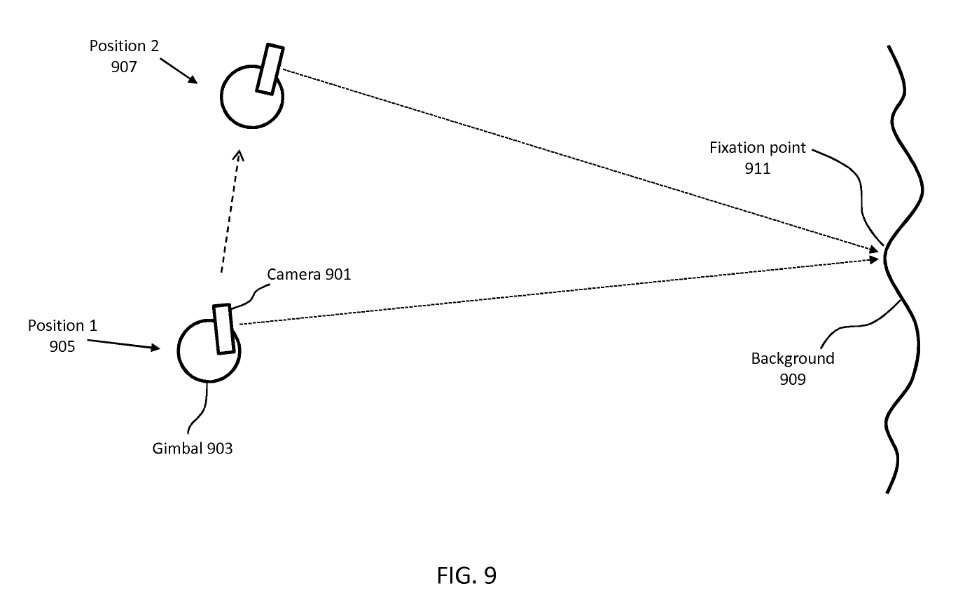

Another application of the above techniques for removing sub-pixel displacements is to process images acquired from a camera mounted on a mechanical gimbal. Refer to FIG. 9, which shows a camera 901 mounted on a gimbal 903 moving from a first position 905 to a second position 907. This may be accomplished by having the gimbal 903 and camera 901 mounted on a moving platform (not shown). The angle setting of the gimbal 903 may be controlled by a processor (not shown) that uses information from an inertial measurement unit (not shown) and video information from the camera 901 to control the gimbal's angular position. The gimbal 903, as represented in FIG. 9, may be a three-axis gimbal capable of rotating the camera through three degrees of freedom or it may be a gimbal having just one or two axes of rotation. Suppose the processor is programmed to keep the camera 901 fixated onto a fixation point 911, located on a background 909. This may be accomplished using a number of techniques well-known in the art. For example, when at the first position 905, the processor may identify a visual feature at or near the fixation point 911 that is easy to track. Then as the platform carrying the gimbal 903 and camera 901 moves, the processor may analyze the visual motion of the texture at the fixation point 911 and adjust the gimbal 903 position so that the fixation point 911 stays in the same location of the image acquired by the camera 901. It is beneficial for the gimbal to rotate the camera along all three axes, so that roll within the camera's image is also stabilized.

It will be understood that the accuracy of the gimbal will be finite, and may be limited by factors such as the accuracy of any inertial measurement unit on the platform, the quality of the gimbaling mechanism including any motion actuators, and/or the accuracy of feature, block, or target tracking algorithms that process the camera's output imagery. As the gimbal 903 moves to track the object, at some time instances it may be “ahead” of the fixation point 911 and at other times “behind”. Suppose a set of images is acquired while the camera and gimbal moves from the first position 905 to the second position 907. Even when whole-pixel jitter is removed, there will still be some residual sub-pixel displacements between images. The lucky pair algorithms 301 and 401 described above may be used to remove these sub-pixel displacements by selecting lucky image pairs with small relative displacements. The resulting lucky image pairs may then be used to measure the local optical flow around the background 909 with greater accuracy and fidelity. Alternatively, parallax between the fixation point 911 and any foreground objects (not shown) in the environment may be readily measured.

### Other Exemplary Embodiments

Let us discuss several additional exemplary embodiments and applications of the above techniques

Incorporating Offset Downsampling

As mentioned above, U.S. patent application Ser. No. 12/852,506 by Barrows entitled “Visual Motion Processing with Offset Downsampling” discloses a technique for acquiring offset downsampled images. Although offset downsampling was mentioned above as a prior art, it can in fact be combined with the above methods of acquiring lucky image pairs as follows: A set of images may be acquired using binning techniques, but different images may be acquired using different offsets. Suppose a total of G different offsets are used. Image I₁ of an image set I may be acquired with a first offset. Image I₂ may be acquired with a second offset, and so on until image I_{G} is acquired with the last offset. Then image I_{G+1} may be acquired with the first offset, and so on. This collection of images may then be processed using the lucky image pair extraction algorithms described above. In order to do this, all possible offsets may be acquired, or a subset of all offsets may be acquired.

With regard to timing, this exemplary embodiment is one in which several images may be acquired simultaneously. More specifically, Images I₁ through I_{G} may be acquired simultaneously, and likewise images I_{G+1} through I_{2G} may be acquired simultaneously, and so on. Of course, these images may also be acquired each at a distinct time instant.

It will be understood that the aforementioned offset downsampling may be implemented in software, or with hardware, for example using any of the techniques described in the aforementioned U.S. patent application Ser. No. 13/078,211 entitled “Vision based hover in place” by Barrows, or using any of the techniques taught in U.S. Pat. No. 7,408,572 by Baxter et. al. entitled “Method and apparatus for an on-chip variable acuity imager array incorporating roll, pitch, and yaw angles rates measurement”, the latter of which is also incorporated herein in entirety by reference.

Use on a Monocopter Type Air Vehicle

FIG. 24 of the aforementioned U.S. patent application Ser. No. 13/078,211 describes a monocopter type air vehicle whose body fully rotates while flying. This air vehicle contains a camera, essentially a line imager that sweeps the entire horizontal field of view as the monocopter rotates. The algorithms described above (e.g. 301, 401, 601, and variants) may be used to process imagery generated by such an image sensor. In one variant, each image of a set may be acquired by one rotation of the monocopter. In another variant, the camera may include several line imagers, each of which generates a separate image as the monocopter rotates. Each of the line imagers may be offset vertically by a fraction of a pixel to cause displacement that may then be negated by the monocopter's movement through the environment. The image sets may then be processed using the above lucky image pair techniques to perform tasks such as detection of a moving object in the environment, detection of narrow obstacles, measurement of divergence, or otherwise measuring local optical flow. It will be understood that this basic technique can be applied to a set of images acquired by a line or other imager mounted so as to spin and thus scan out 2D images.

I claim:

1. A method of generating a set of image pairs based on a visual scene, comprising the steps of:
acquiring a plurality of images based on the visual scene;
generating a plurality of measurements based on the plurality of images, wherein each measurement of the plurality of measurements is associated with two images selected from the plurality of images;
selecting a subset of measurements from the plurality of measurements; and
generating the set of image pairs based on the two images associated with each measurement of the subset of measurements.

2. The method of claim 1, wherein the plurality of images is acquired using a moving camera.

3. The method of claim 1, wherein the plurality of measurements is generated based on a function.

4. The method of claim 3, wherein the function is selected from the group consisting of a similarity metric and a dissimilarity metric.

5. The method of claim 3, wherein the function comprises a distance metric.

6. The method of claim 1, wherein the step of acquiring a plurality of images based on the visual scene comprises a step of removing whole pixel displacements from the plurality of images.

7. The method of claim 1, wherein the set of image pairs is a set of lucky image pairs.

8. The method of claim 1, wherein the two images of each image pair of the set of image pairs have a substantially reduced sub-pixel displacement with respect to each other.

9. The method of claim 1, wherein:
the plurality of images comprises a first set of images and a second set of images;
the first set of images is acquired during a first time interval, the second set of images is acquired during a second time interval, and the first time interval is nonoverlapping with the second time interval; and
each measurement of the plurality of measurements is additionally associated with one image from the first set of images and one image from the second set of images.

10. The method of claim 1, wherein each image of the plurality of images is acquired at a different time instant.

11. The method of claim 1, wherein the subset of measurements is selected from the plurality of measurements by a method selected from the group consisting of selecting the most positive measurements from the plurality of measurements and selecting the least positive measurements from the plurality of measurements.

12. A method of generating a set of image pairs based on a visual scene, comprising the steps of:
acquiring a plurality of images based on the visual scene;
defining a plurality of image pairs based on the plurality of images, wherein each image pair of the plurality of image pairs comprises two images selected from the plurality of images;
generating a plurality of measurements based on the plurality of image pairs; and
generating the set of image pairs based on the plurality of measurements and the plurality of image pairs.

13. The method of claim 12, wherein the plurality of images is acquired using a moving camera.

14. The method of claim 12, wherein the plurality of measurements is generated based on a function.

15. The method of claim 14, wherein the function comprises a distance metric.

16. The method of claim 12, wherein the step of acquiring a plurality of images based on the visual scene comprises a step of removing whole pixel displacements from the plurality of images.

17. The method of claim 12, wherein the set of image pairs is a set of lucky image pairs.

18. The method of claim 12, wherein:
the plurality of images comprises a first set of images and a second set of images;
the first set of images is acquired during a first time interval, the second set of images is acquired during a second time interval, and the first time interval is nonoverlapping with the second time interval; and
each image pair of the plurality of image pairs comprises an image selected from the first set of images and an image selected from the second set of images.

19. A method of generating a set of image pairs based on a visual scene, comprising the steps of:
acquiring a plurality of images based on the visual scene;
generating a plurality of measurements based on the plurality of images, wherein each measurement of the plurality of measurements is associated with a pair of images selected from the plurality of images;
selecting a subset of measurements from the plurality of measurements; and
generating the set of image pairs based on the subset of measurements and the plurality of images.

20. The method of claim 19, wherein the sub-pixel displacement between the two images of each image pair of the set of image pairs is substantially less than one pixel.
